(19) United States
(12) Patent Application Publication
(10) Pub. No.: US 2022/0322823 A1
(43) Pub. Date: Oct. 13, 2022

(54) LAPTOP STAND

(71) Applicant: ANFU CE LINK LIMITED, Jian City (CN)

(72) Inventor: HONGLIANG ZHOU, JIAN CITY (CN)

(21) Appl. No.: 17/690,060

(22) Filed: Mar. 9, 2022

(30) Foreign Application Priority Data
Apr. 9, 2021 (CN) 202120728709.9

(51) Int. Cl. A47B 23/04; G06F 1/16

(52) U.S. Cl. CPC A47B 23/043; G06F 1/1632; A47B 2023/049

(57) ABSTRACT

A laptop stand comprising a stand body is provided, wherein the stand body comprises a left frame body (100) and a right frame body (200), and a spacing adjustment mechanism (300) is arranged between the left frame body (100) and the right frame body (200) to adjust a width of the stand body. Not only can the laptop stand be applied to laptops of different sizes, but also when not in use, the width of the laptop stand can be reduced by the spacing adjustment mechanism, which is convenient for storage and carrying.

### FIELD OF THE DISCLOSURE

The present disclosure relates to a laptop stand, in particular, to a laptop stand with adjustable width.

### BACKGROUND OF THE DISCLOSURE

The laptop stand is used to support the laptop. The current laptop stand is of a fixed size and large in size, and has the defect of inconvenient storage and carrying.

### SUMMARY OF THE DISCLOSURE

The purpose of the present invention is to provide a laptop stand to solve the above-mentioned defects in the prior art.

To achieve the above objectives, the technical solutions adopted by the present disclosure are as follows.

A laptop stand comprising a stand body is provided, wherein the stand body comprises a left frame body and a right frame body, and a spacing adjustment mechanism is arranged between the left frame body and the right frame body to adjust a width of the stand body.

Preferably, the spacing adjustment mechanism comprises a first rod body of which one end is hinged with the left frame and the other end is slidably fitted with a sliding groove on the right frame, and a second rod body of which one end is hinged with the right frame and the other end is slidably fitted with a sliding groove on the left frame, and a middle portion of the second rod body is hinged with a middle portion of the first rod body.

Preferably, each of the left frame body and the right frame body comprises a bottom plate and a top plate arranged above the bottom plate and of which one end is hinged with the bottom plate, and a support rod arranged between the top plate and the bottom plate and of which one end is hinged with the top plate; wherein the bottom plate is provided with a plurality of angle adjustment holes configured to coordinate with the other end of the support rod to adjust an angle between the top plate and the bottom plate.

Preferably, the top plate is also provided with a receiving hole of the support rod on one side corresponding to a hinged part of the support rod.

Preferably, an anti-slip part and an upward convex part are provided on an end of a top of the bottom plate adjacent to a hinge end of the top plate.

Preferably, an end of the bottom plate is provided with a folded part and the folded part and a bottom of the bottom plate form a card slot.

Preferably, a bottom of the folded portion and a top of the top plate are each provided with a rubber pad.

Preferably, at least one of the left frame body and the right frame body is provided with a USB docking station.

Preferably, a USB docking station is further provided, wherein one end of the USB docking station is embedded in the card slot and fixed to the bottom plate.

Preferably, the bottom plate is provided with a cord clamp, and an extension cable of the USB docking station is attached to the bottom plate through the cord clamp.

Compared with the prior art, the present disclosure has at least the following beneficial effects.

The present disclosure is suitable for laptops of different sizes, and when not in use, the width of the laptop stand can be reduced by the spacing adjustment mechanism, which is convenient for storage and carrying.

The present disclosure is further equipped with a USB docking station, which can easily extend the interface of the laptop.

The present disclosure further adopts a specific spacing adjustment mechanism, which has the characteristics of convenient adjustment and stable support.

The present disclosure is further provided with a receiving hole for the support rod, and the support rod is in the receiving hole during storage, which can further reduce the volume of the bracket in the storage state.

The present disclosure further snaps one end of the USB docking station into the slot of the bottom plate, making the combination of the docking station and the stand more convenient and firm.

The extension cable of the USB docking station is attached to the bottom plate through the cord clamp of the bottom plate, so that the stand is more tidy and beautiful.

### BRIEF DESCRIPTION OF THE DRAWINGS

FIG. 1 is a perspective view of the storage state of the laptop stand.

FIG. 2 is an exploded view of FIG. 1.

FIG. 3 is a state diagram of the USB docking station and its extension cable on the back of the storage state.

FIG. 4 is a state diagram of the left frame body and the right frame body after unfolding.

FIG. 5 is a state diagram of the top plate at an inclination angle.

FIG. 6 is a state diagram of the top plate at another inclination angle.

Reference numeral: 100: left frame body; 200: right frame body; 300: spacing adjustment mechanism; 400: USB docking station; 101: angle adjustment hole; 102: pin shaft; 103: rubber pad; 104: folded part; 105: card slot; 106: bottom plate; 107: support rod; 108: top plate; 109: receiving hole; 110: sliding groove; 111: anti-slip part; 112: convex part; 301: first rod body; 302: second rod body; 401: extension cable; 402: cord clamp

### DETAILED DESCRIPTION OF THE EXEMPLARY EMBODIMENTS

The present disclosure will be further described below in conjunction with the drawings and embodiments.

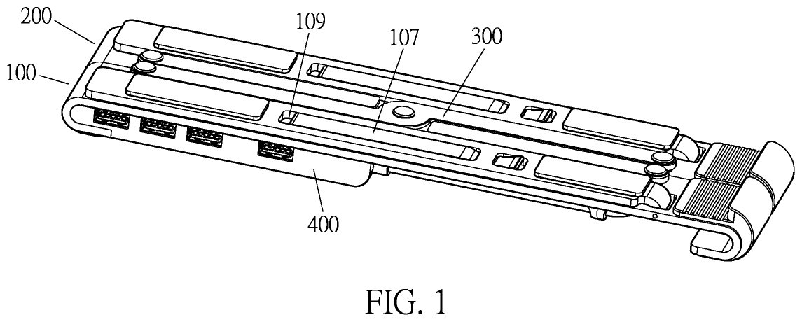

Reference is made to FIG. 1 to FIG. 6. A laptop stand includes a stand body and a USB docking station 400. The stand body includes a left frame body 100 and a right frame body 200. A spacing adjustment mechanism 300 is provided between the left frame body 100 and the right frame body 200, to adjust a width of the stand body.

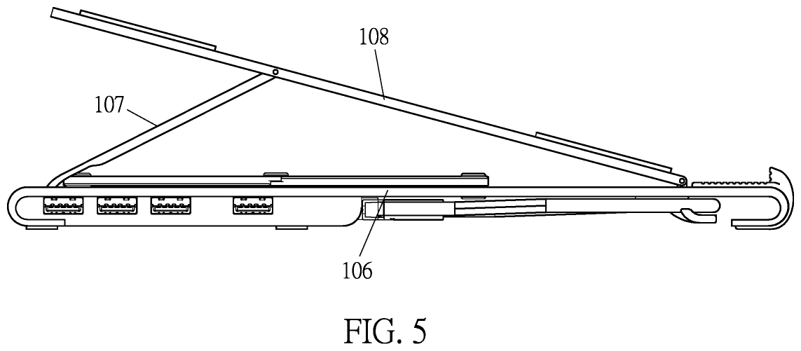

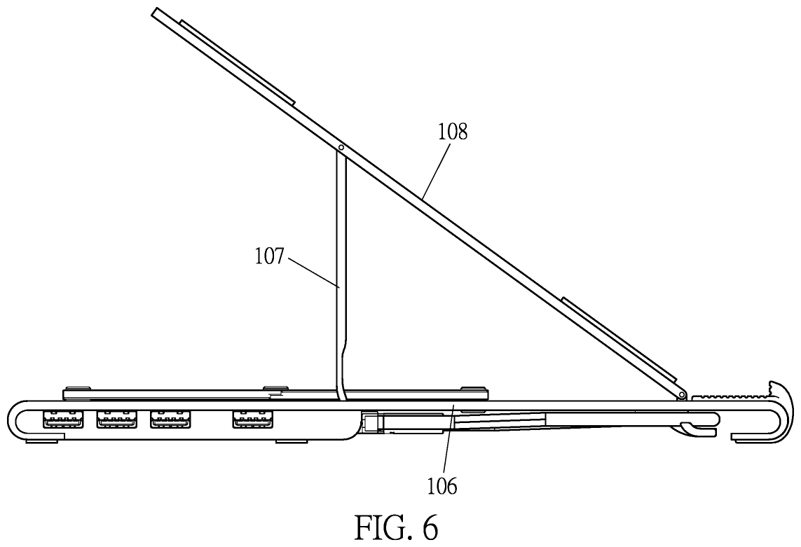

Take the left frame body as an example. The left frame body includes a bottom plate 106, a top plate 108, and a support rod 107. The edge of the bottom plate 106 is provided with a sliding groove 110. The bottom plate 106 is also provided with a plurality of angle adjustment holes 101. The top plate 108 is located above the bottom plate 106. One end of the top plate 108 is hinged with the bottom plate 106 through the pin shaft 102, the top end of the support rod 107 is hinged with the top plate 108 through the pin shaft 102, and the bottom end of the support rod 107 is mated with the angle adjustment hole 101 on the bottom plate 106 to keep the top plate 108 in an inclined state. By inserting the bottom end of the support rod 107 into the different angle adjustment holes 101, the inclination angle of the top plate 108 can be adjusted, that is, the angle between the top plate 108 and the bottom plate 106 can be adjusted. In this embodiment, the included angle is designed to be a minimum of 15 degrees (as shown in FIG. 5) and a maximum of 36 degrees (as shown in FIG. 6).

Furthermore, the top plate 108 is also provided with a receiving hole 109 of the support rod 107 on one side corresponding to a hinged part of the support rod 107. As shown in FIG. 1, when the top plate 108 is laid flat, the support rod 107 is received into the receiving hole 109, which can further reduce the volume of the stand and also help maintain the stability of the stand.

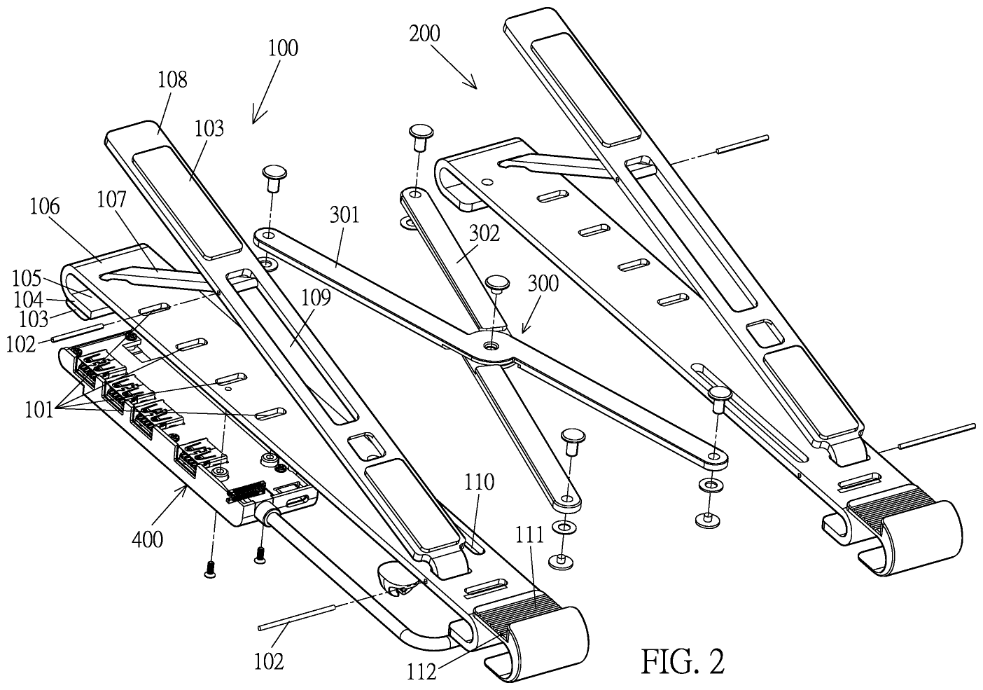

Furthermore, the end of the bottom plate 106 adjacent to the hinged end of the top plate 108 is provided with a rubber sleeve, and the top of the rubber sleeve has an anti-slip part 111 (see FIG. 2) and an upward convex part 112 (see FIG. 2). When the laptop is placed on the top plate 108, the edge of the laptop abuts against the convex part 112, and the edge of the laptop contacts the anti-slip part 111, which can better prevent the laptop from sliding on the top plate 108.

Furthermore, the end of the bottom plate 106 has a folded part 104, and the folded part 104 and a bottom of the bottom plate 106 form a card slot 105.

Further, the bottom of the folded part 104 and the top of the top plate 108 are respectively provided with rubber pads 103, which can better prevent the stand from sliding on the supporting surface and the laptop from sliding on the stand.

The structure of the right frame body 200 is basically the same as that of the left frame body 100, and will not be repeated here.

The spacing adjustment mechanism 300 comprises a first rod body 301 of which one end is hinged with the bottom plate 106 of the left frame body 100 and the other end is slidably fitted with a sliding groove 110 on the bottom plate 106 of the right frame body 200, and a second rod body 302 of which one end is hinged with the bottom plate 106 of the right frame body 200 and the other end is slidably fitted with a sliding groove 110 on the bottom plate 106 of the left frame body 100, and the middle part of the second rod body 302 and the middle part of the first rod body 301 are hinged by a pin shaft. When the left frame body 100 and the right frame body 200 are squeezed from both sides to the middle, the first rod body 301 and the second rod body 302 rotate around their hinged parts, which can easily reduce the gap between the left frame body 100 and the right frame body 200. To reduce the width of the laptop stand, on the contrary, the user can increase the width of the laptop stand. With the above-mentioned spacing adjustment mechanism 300, the spacing adjustment mechanism 300 and the left frame body 100, and the spacing adjustment mechanism 300 and the right frame body 200 are all connected by multiple points, and the multiple points have a relatively large spacing, thus having strong stability.

The laptop stand further includes a USB docking station 400, and the USB docking station 400 is preferably a TYPE-C docking station. One end of the USB docking station 400 is embedded in the card slot 105 of the bottom plate 106 of the left frame body 100 and is fixed to the bottom plate 106 by screws. The card slot 105 is used to embody the combination of the USB docking station 400 and the stand, which has the characteristics of convenient and firm combination.

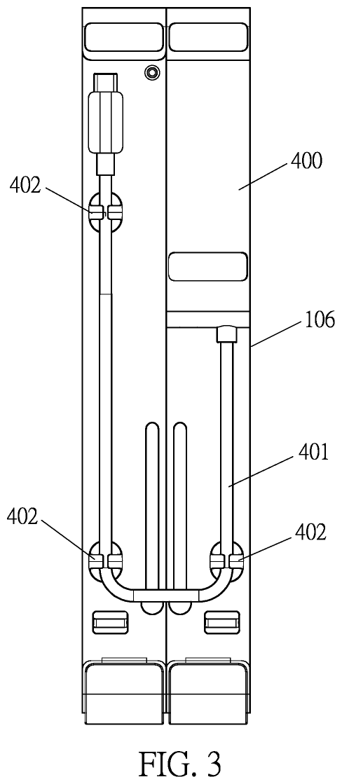

Reference is made to FIG. 3. A cord clamp 402 is further provided on the bottom plate 106, and an extension cord 401 of the USB docking station 400 is attached to the bottom plate 106 through the cord clamp 402, which is beneficial to the tidy and beautiful appearance of the stand.

The usage method of this laptop stand is as follows.

The storage state is shown in FIG. 1. The left frame body 100 and the right frame body 200 are closed together, and the top plate 108 and the bottom plate 106 are stacked together. The overall volume is small, which is convenient for storage and carrying.

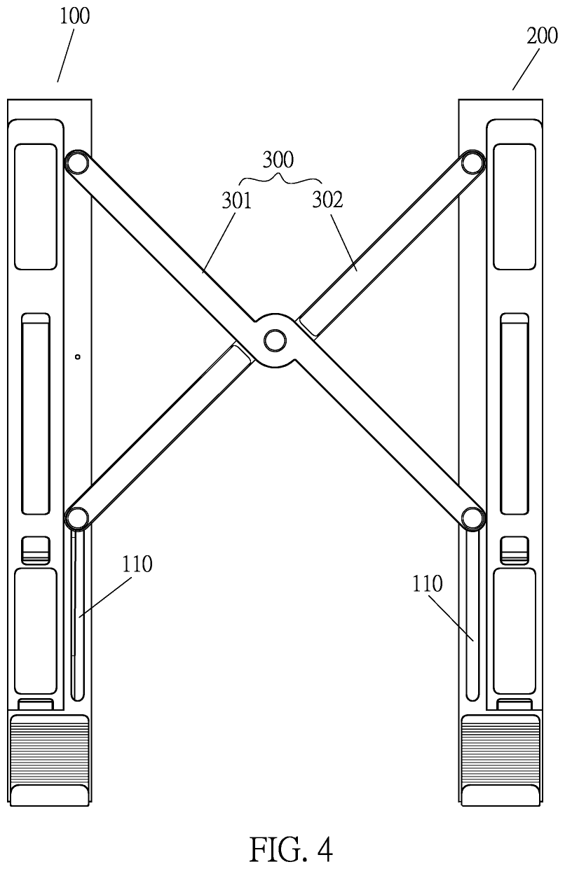

When in use, the left frame body 100 and the right frame body 200 are pulled in the left and right directions, as shown in FIG. 4, until the width is adapted to the width of the laptop, then the top plate 108 is lifted, the support rod 107 is rotated, the lower end of the support rod 107 is inserted into an angle adjustment hole 101 on the bottom plate 106, the top plate 108 is supported in the required inclination state (as shown in FIG. 5 or FIG. 6), and the laptop is placed on the top plate 108. When it is necessary to extend the interface of the laptop, the extension cable 401 of the USB docking station 400 is removed from the stand and is inserted into the USB interface of the laptop.

It can be seen that the above-mentioned laptop stand can conveniently adjust the width of the stand and adjust the angle between the top plate 108 and the bottom plate 106, so that when not in use, the volume of the stand is greatly reduced, which is convenient for storage and carrying. The present disclosure adopts a special spacing adjustment structure, which has the characteristics of convenient and stable adjustment. The top plate 108 is provided with a receiving hole 109 of the support rod 107, which is beneficial to further miniaturization of the support and helps to maintain the stability of the support. The present disclosure is equipped with a USB docking station 400, which is convenient for the expansion of the laptop interface.

The present disclosure has been described in detail through specific embodiments above. These detailed descriptions are only limited to helping those skilled in the art understand the content of the present disclosure, and should not be construed as limiting the protection scope of the present disclosure. Various modifications, equivalent transformations, etc., performed by those skilled in the art on the above solutions under the concept of the present disclosure should all be included in the protection scope of the present disclosure.

What is claimed is:

1. A laptop stand comprising a stand body, wherein the stand body comprises a left frame body (100) and a right frame body (200), and a spacing adjustment mechanism (300) is arranged between the left frame body (100) and the right frame body (200) to adjust a width of the stand body.

2. The laptop stand according to claim 1, wherein the spacing adjustment mechanism (300) comprises
a first rod body (301) of which one end is hinged with the left frame body (100) and the other end is slidably fitted with a sliding groove (110) on the right frame body (200); and
a second rod body (302) of which one end is hinged with the right frame body (200) and the other end is slidably fitted with a sliding groove (110) on the left frame body (100),
wherein a middle portion of the second rod body (302) is hinged with a middle portion of the first rod body (301).

3. The laptop stand according to claim 1, wherein each of the left frame body (100) and the right frame body (200) comprises:
a bottom plate (106) and a top plate (108) arranged above the bottom plate (106) and of which one end is hinged with the bottom plate (106); and
a support rod (107) arranged between the top plate (108) and the bottom plate (106) and of which one end is hinged with the top plate (108),
wherein the bottom plate (106) is provided with a plurality of angle adjustment holes (101) configured to coordinate with the other end of the support rod (107) to adjust an angle between the top plate (108) and the bottom plate (106).

4. The laptop stand according to claim 3, wherein the top plate (108) is also provided with a receiving hole (109) of the support rod (107) on one side corresponding to a hinged part of the support rod (107).

5. The laptop stand according to claim 3, wherein an anti-slip part (111) and an upward convex part (112) are provided on an end of a top of the bottom plate (106) adjacent to a hinge end of the top plate (108).

6. The laptop stand according to claim 3, wherein an end of the bottom plate (106) is provided with a folded part (104) and the folded part (104) and a bottom of the bottom plate (106) form a card slot (105).

7. The laptop stand according to claim 6, wherein a bottom of the folded portion (104) and a top of the top plate (108) are each provided with a rubber pad (103).

8. The laptop stand according to claim 1, wherein at least one of the left frame body (100) and the right frame body (200) is provided with a USB docking station (400).

9. The laptop stand according to claim 2, wherein at least one of the left frame body (100) and the right frame body (200) is provided with a USB docking station (400).

10. The laptop stand according to claim 3, wherein at least one of the left frame body (100) and the right frame body (200) is provided with a USB docking station (400).

11. The laptop stand according to claim 4, wherein at least one of the left frame body (100) and the right frame body (200) is provided with a USB docking station (400). 12 The laptop stand according to claim 5, wherein at least one of the left frame body (100) and the right frame body (200) is provided with a USB docking station (400).

13. The laptop stand according to claim 6, wherein at least one of the left frame body (100) and the right frame body (200) is provided with a USB docking station (400).

14. The laptop stand according to claim 7, wherein at least one of the left frame body (100) and the right frame body (200) is provided with a USB docking station (400).

15. The laptop stand according to claim 6, further comprising a USB docking station (400), wherein one end of the USB docking station (400) is embedded in the card slot (105) and fixed to the bottom plate (106).

16. The laptop stand according to claim 15, wherein the bottom plate (106) is provided with a cord clamp (402), and an extension cord (401) of the USB docking station (400) is attached to the bottom plate (106) through the cord clamp (402).
